(19) United States
(12) Patent Application Publication
(10) Pub. No.: US 2023/0183880 A1
(43) Pub. Date: Jun. 15, 2023

(54) FLUID SENSOR PACKAGE

(71) Applicant: TEXAS INSTRUMENTS INCORPORATED, Dallas, TX (US)

(72) Inventors: Sebastian MEIER, Muenchen (DE); Bernhard ZIEGLTRUM, Freising (DE)

(21) Appl. No.: 18/081,637

(22) Filed: Dec. 14, 2022

Related U.S. Application Data
(60) Provisional application No. 63/289,659, filed on Dec. 15, 2021.

(51) Int. Cl. C25D 7/00; G01M 3/16; C25D 3/46; C25D 3/48; C25D 5/48

(52) U.S. Cl. CPC C25D 7/00; C25D 3/46; C25D 3/48; C25D 5/48; G01M 3/16

(57) ABSTRACT

In examples, an apparatus comprises a substrate having opposite first and second surfaces. The substrate includes a first opening through the substrate. The substrate includes a first sealing layer covering an inner surface of the first opening, with the inner surface extending between the first and second surfaces. The substrate includes contact pads on the second surface. The apparatus also comprises a fluid sensor having a sensor surface facing the second surface and the first opening. The apparatus further includes metal interconnects coupled between the sensor surface and the contact pads. The apparatus also includes a second sealing layer between the second surface and the sensor surface, in which the second sealing layer surrounds the metal interconnects and includes a second opening below the first opening, and at least part of the sensor surface is exposed through the first and second openings.

### CROSS-REFERENCE TO RELATED APPLICATIONS

The present application claims priority to U.S. Provisional Pat. Application No. 63/289,659, which was filed Dec. 15, 2021, is titled “Flip Chip PCB With Gold Coated Via For Liquid Sensing,” and is also related to U.S. Pat. Application No. 18/066,206, titled “Integrated Circuit Fluid Sensor,” Attorney Docket Number T101555US03, filed on Dec. 14, 2022, all of which are hereby incorporated herein by reference in their entireties.

### BACKGROUND

Integrated circuits (ICs) may perform various functions. In some applications, ICs are useful as sensors. For example, a sensor IC may sense properties in the environment of the IC, such as temperature, humidity, pressure, windspeed, etc. Similarly, a sensor IC may sense properties of a material, such as the properties of a fluid that comes in contact with a sensing area of the sensor IC.

### SUMMARY

In examples, an apparatus comprises a substrate having opposite first and second surfaces. The substrate includes a first opening through the substrate. The substrate includes a first sealing layer covering an inner surface of the first opening, with the inner surface extending between the first and second surfaces. The substrate includes contact pads on the second surface. The apparatus also comprises a fluid sensor having a sensor surface facing the second surface and the first opening. The apparatus further includes metal interconnects coupled between the sensor surface and the contact pads. The apparatus also includes a second sealing layer between the second surface and the sensor surface, in which the second sealing layer surrounds the metal interconnects and includes a second opening below the first opening, and at least part of the sensor surface is exposed through the first and second openings.

In examples, a method comprises forming a substrate having opposite first and second surfaces and a first opening extending between the first and second surfaces; forming a first sealing layer on an inner surface of the first opening; mounting a fluid sensor on metal interconnects on the second surface of the substrate, the fluid sensor having a sensing area facing the first opening; and forming a second sealing layer between the second surface of the substrate and the fluid sensor and around the metal interconnects, the second sealing layer having a second opening between the first opening and the sensing area, such that the sensing area is exposed through the first and second openings.

### BRIEF DESCRIPTION OF THE DRAWINGS

FIG. 1 is a schematic illustrating a cross-sectional view of an electronic device including a fluid sensor package, in accordance with various examples.

FIG. 2A is a schematic illustrating a cross-sectional view of a fluid sensor package, in accordance with various examples.

FIG. 2B is a schematic illustrating a cross-sectional view of a fluid sensor package mounted on a substrate and coupled to a container, in accordance with various examples.

FIG. 3 is a schematic illustrating a top view of a fluid sensor package mounted on a substrate and coupled to a container, in accordance with various examples.

FIG. 4 is a schematic illustrating a bottom view of a fluid sensor package coupled to a container, in accordance with various examples.

FIG. 5 is a schematic illustrating a bottom view of a substrate of a fluid sensor package, in accordance with various examples.

FIG. 6 is a schematic illustrating a top view of a substrate of a fluid sensor package, in accordance with various examples.

FIG. 7 is a schematic illustrating a perspective view of a substrate of a fluid sensor package, in accordance with various examples.

FIG. 8 are schematics illustrating cross-sectional views of sealing layers of a fluid sensor package, in accordance with various examples.

FIG. 9 is a schematic illustrating a cross-sectional view of a fluid sensor package and a cartridge, in accordance with various examples.

FIG. 10 is a schematic illustrating a top view of a fluid sensor package, in accordance with various examples.

FIG. 11 is a schematic illustrating a bottom view of a substrate of a fluid sensor package, in accordance with various examples.

FIG. 12 is a schematic illustrating a cross-sectional view of a fluid sensor package, in accordance with various examples.

FIG. 13 is a schematic illustrating a top view of a fluid sensor package, in accordance with various examples.

FIG. 14 is a schematic illustrating a bottom view of a substrate of a fluid sensor package, in accordance with various examples.

FIG. 15 is a schematic illustrating a cross-sectional view of a fluid sensor package, in accordance with various examples.

FIG. 16 is a schematic illustrating a top view of a fluid sensor package, in accordance with various examples.

FIG. 17 is a schematic illustrating a bottom view of a substrate of a fluid sensor package, in accordance with various examples.

FIG. 18 is a schematic illustrating a top view of a fluid sensor package, in accordance with various examples.

FIG. 19 is a schematic illustrating a bottom view of a fluid sensor package, in accordance with various examples.

FIG. 20 is a flow diagram illustrating a method for manufacturing a fluid sensor package, in accordance with various examples.

### DETAILED DESCRIPTION

As described above, sensor ICs may sense various properties of a fluid. The sensor IC has a sensing area over which the fluid flows. As the fluid flows over the sensing area, the sensor IC generates data pertaining to the fluid and provides the data to other electronic devices (e.g., a processor) for processing. In some applications, a sensor IC may be mounted on a printed circuit board (PCB), such as a flame retardant 4 (FR-4) PCB. As the fluid to be sensed flows toward the sensor IC, the fluid may come into contact with the PCB. The PCB surface may include organic material, and this organic material may alter one or more properties of the fluid and compromise the sensing operation. Further, the PCB may include metal interconnects, such as pads, vias, and traces, on its surface. If the fluid is on the PCB surface and comes into contact with metal interconnects that are configured to carry data signals, it may create short circuits, which may damage other components coupled to the PCB, such as the sensor IC.

This disclosure describes examples of devices that can mitigate the challenges described above. In particular, an example device includes a substrate (e.g., FR-4 PCB) having opposite first and second surfaces. The substrate includes a first opening extending through the substrate, from the first surface to the second surface. A fluid to be sensed may flow through the first opening. The substrate also includes a first sealing layer (e.g., including an inner copper sub-layer, a nickel sub-layer, a palladium sub-layer, and an outer gold or silver sub-layer) covering an inner surface of the first opening, where the inner surface extends between the first and second surfaces. The first sealing layer can provide a surface having a higher degree of wettability than porous surface of the substrate material. The first sealing layer can prevent the fluid from contacting the porous surface of the substrate, or at least reduce the likelihood of the fluid contacting the porous surface. The device also includes contact pads on the second surface, and a fluid sensor (e.g., a sensor IC) having a sensor surface facing the second surface and the first opening. The device includes metal interconnects coupled between the sensor surface and the contact pads. The device includes a second sealing layer between the second surface and the sensor surface, in which the second sealing layer surrounds the metal interconnects and includes a second opening below the first opening. The second sealing layer can prevent the fluid from contacting the metal interconnects and creating short circuits, or at least reduce the likelihood of such an event. At least part of the sensor surface is exposed through the first and second openings.

During operation, the fluid flows through the first opening, which is covered by the first sealing layer. The fluid flows through the second opening and contacts the sensor surface of the fluid sensor. The fluid sensor can generate data by sensing various properties of the fluid. Because the inner surface of the first opening is covered by the first sealing layer, the contact between the fluid and the porous substrate surface can be reduced, which can maintain the properties of the fluid. Also, as described above, the second sealing layer can reduce/prevent the contact between the fluid and the metal interconnects, which can reduce the likelihood of short circuits. All these can improve the robustness and safety of operation of the fluid sensor.

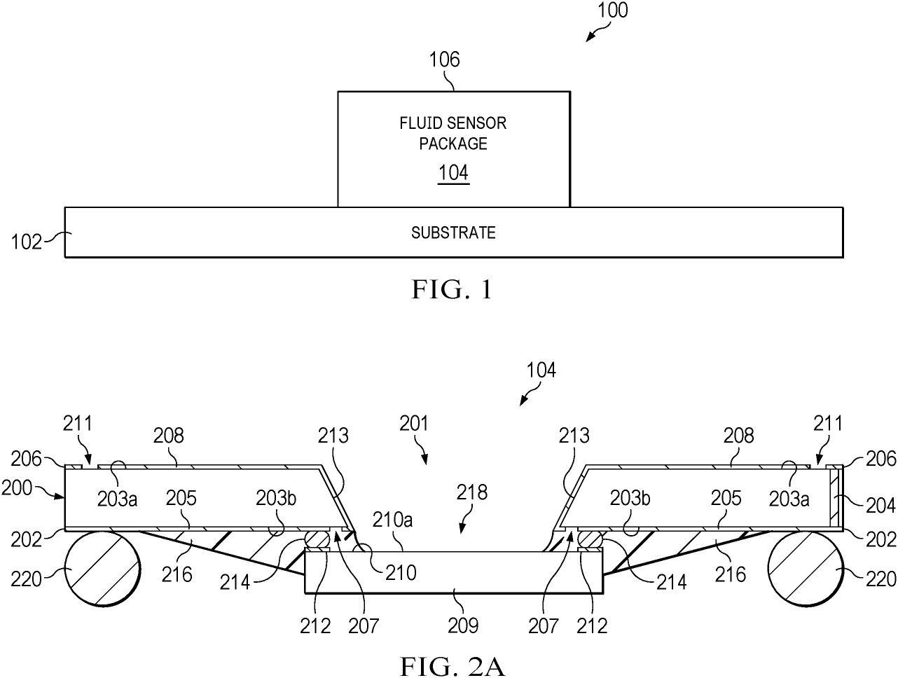

FIG. 1 is a schematic illustrating a cross-sectional view of an electronic device including a fluid sensor package, in accordance with various examples. Specifically, an electronic device 100 includes a substrate 102 (e.g., PCB) on which a fluid sensor package 104 is mounted. Other electronic components such as integrated circuits and passive/active electronic devices (not shown in FIG. 1) may also be mounted on substrate 102, which can include interconnects to provide electrical connectivity between fluid sensor package 104 and the other electronic components.

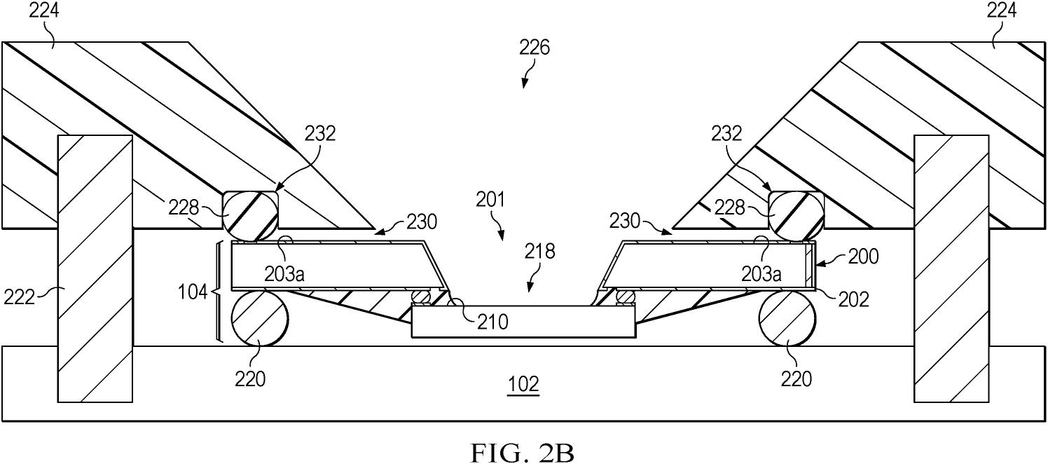

The electronic device 100 may be any suitable device in any suitable sensing application. In examples, the electronic device 100 may be part of a smartphone, an appliance, a swimming pool monitor, industrial equipment, an automobile, an aircraft, a spacecraft, etc. The fluid sensor package 104 is positioned such that a fluid inlet (also referred to herein as an opening; not expressly shown in FIG. 1, but shown in other drawings, such as in FIG. 2) is coincident with a surface 106 of the electronic device 100. In some examples, surface 106 can also be exposed directly to an exterior of the electronic device 100. In both cases, a fluid can come into contact with the fluid sensor package 104, and the fluid sensor package 104 can sense one or more properties of the fluid.

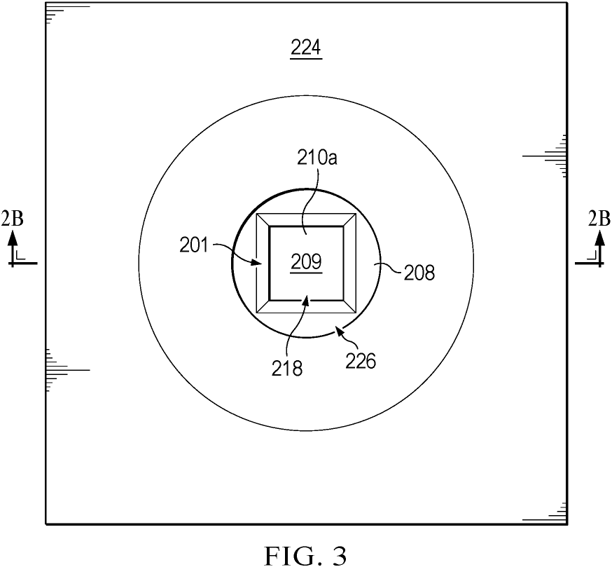

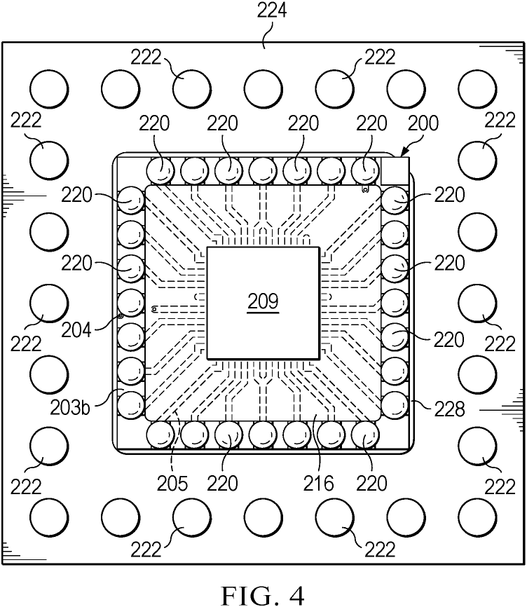

FIG. 2A is a schematic illustrating a cross-sectional view of a fluid sensor package, and FIG. 2B is a schematic illustrating a cross-sectional view of a fluid sensor package mounted on a substrate and coupled to a container. FIG. 3 is a schematic illustrating a top view of the fluid sensor package mounted on the substrate and coupled to a container, and FIG. 4 is a schematic illustrating a bottom view of the fluid sensor package without the substrate and coupled to a container, in accordance with various examples. Specifically, FIGS. 2A, 2B, 3, and 4 show examples of the fluid sensor package 104 (shown mounted on the substrate 102 in FIGS. 2B and 3, although the substrate 102 is not visible in the top view of FIG. 3). The fluid sensor package 104 includes a substrate 200 (e.g., a PCB, such as an FR-4 PCB). The substrate 200 includes an opening 201 extending through the substrate 200 (e.g., extending between the opposing top surface 203a and bottom surface 203b of the substrate 200). In examples, the opening 201 has an approximately constant diameter. In examples, the opening 201 has recessed inner surfaces 213, and the diameter of the opening 201 decreases from the top surface 203a to the bottom surface 203b of the substrate 200, as FIG. 2A shows. The substrate 200 includes metal interconnects 202, 204, 205, and 206, some or all of which may be coupled to each other. In examples, the metal interconnects 202 are contact pads (e.g., bond pads) on the bottom surface of the substrate 200. In examples, the metal interconnects 204 are vias that extend between the bottom surface 203b of the substrate 200 to the top surface 203a of the substrate 200. In examples, the metal interconnects 205 are metal traces on the bottom surface 203b of the substrate 200. In examples, the metal interconnects 206 form a metal ring, or an electrode, on the top surface 203a of the substrate 200 (e.g., for fluid leakage sensing, as described below). Metal interconnects 204 may couple between metal interconnects 206 and each of metal interconnects 202 and 205.

A sealing layer 208 covers the inner surface of the opening 201, as FIG. 2A shows. The sealing layer 208 may cover a portion of the top surface 203a of the substrate 200. The sealing layer 208 may cover a portion of the bottom surface 203b of the substrate 200. In examples, the sealing layer 208 covers all areas of the substrate 200 that may be directly exposed to the fluid to be sensed. Sealing layer 208 can provide a surface having a higher degree of wettability than the porous surface of the material of the substrate 200. The sealing layer 208 can prevent the fluid from contacting the porous surface of the substrate 200, or at least reduce the likelihood of the fluid contacting the porous surface, which could otherwise alter the properties of the fluid being sensed. Example compositions of the sealing layer 208 are described below. On the bottom surface 203b of the substrate 200, a gap 207 separates the sealing layer 208 from the metal interconnects 205. On the top surface of the substrate 200, a gap 211 separates the sealing layer 208 from the metal interconnects 206.

The fluid sensor package 104 includes a sensor IC 209 (e.g., a semiconductor die having a sensor formed therein). In examples, the sensor IC 209 is configured to sense one or more properties of a fluid, such as a pH value, a concentration of a particular ion, etc. The sensor IC 209 has a sensor surface 210 including a sensing area 210a. Fluid may come into contact with the sensing area 210a to enable the sensor IC 209 to sense properties of the fluid. The sensor surface 210 of the sensor IC 209 may include contact pads 212 that are coupled to the metal interconnects 205 by way of metal interconnects 214. In examples, the metal interconnects 214 may be metal (e.g., copper) pillars, solder members, or a combination thereof.

A sealing layer 216 is positioned between the bottom surface 203b of the substrate 200 and the top surface of the sensor IC 209 and surrounds the metal interconnects 214 and the contact pads 212. The sealing layer 216 also includes an opening 218 between opening 201 and sensing area 210a. The sealing layer 216 can prevent the fluid that flows through opening 201 from coming into contact with the metal interconnects 214. The sealing layer 216 may include an electrical insulation material, such as epoxy, to electrically insulate metal interconnects 214 from the fluid. In some examples, the sealing layer 216 can be in the form of an adhesive. In some examples, the sealing layer 216 may include anisotropic conductive film (ACF), and in such examples, the ACF may provide vertical electrical communication pathways in lieu of the metal interconnects 214. Accordingly, the metal interconnects 214 may be omitted in examples that include ACF for the sealing layer 216. The sealing layer 216 may cover none, some, or all of the metal interconnects 202 and 205 and the sealing layer 208. In examples, the sealing layer 216 is formed by applying an epoxy near the metal interconnects 214, and capillary action causes the epoxy to extend through the space between the bottom surface 203b of the substrate 200 and the sensor surface 210 of the sensor IC 209, toward the sensing area 210a. The capillary action can cause the epoxy to form a curved or sloped surface at the opening 218, as FIG. 2 shows. In some examples, the sealing layer 216 is formed by applying a layer of adhesive on the sensor surface 210 of the sensor IC 209 and/or on the bottom surface 203b of the substrate 200 and surrounding the metal interconnects 214, followed by mounting the sensor IC 209 on the metal interconnects 214.

Properties of the sealant can be selected to prevent the sealant from covering the sensing area 210a, thereby forming the opening 218. If epoxy is used as the sealant for the sealing layer 216, and if the epoxy is dispensed without heating, the viscosity of the epoxy may be between 5,000 centiPoise (cP) and 15,000 cP. In some examples, a higher viscosity epoxy may be used and its viscosity then reduced by pre-heating the epoxy dispense tool to approximately 50° C. before application, or by pre-heating the epoxy to approximately 40° C. to 50° C. The viscosity will be reduced by approximately 50% with every 10° C. temperature increase. When selecting an epoxy for the sealing layer 216, an epoxy with low outgassing (e.g., low ion release and/or low fluid uptake) can also be desirable.

In addition, fluid sensor package 104 may include solder members 220 (e.g., solder balls) coupled to metal interconnects 202 (e.g., contact pads). The metal interconnects 202 couple to the substrate 102. The fluid sensor package 104 may also be coupled to a container 224 (e.g., a polyether ether ketone (PEEK) container) by way of support members 222. The container 224 may include an opening 226 through which fluid to be tested may enter the openings 201 and 218 to access the sensing area 210. A sealing ring 228 (e.g., an O-ring) may be positioned between the container 224 and the top surface 203a of the substrate 200 to prevent fluid from leaking through a gap 230 between the container 224 and the top surface 203a of the substrate 200. In examples, the container 224 includes a trench 232 in which the sealing ring 228 is contained. The support members 222 may be useful to establish and maintain proper alignment between the container 224, the substrate 102, and the fluid sensor package 104.

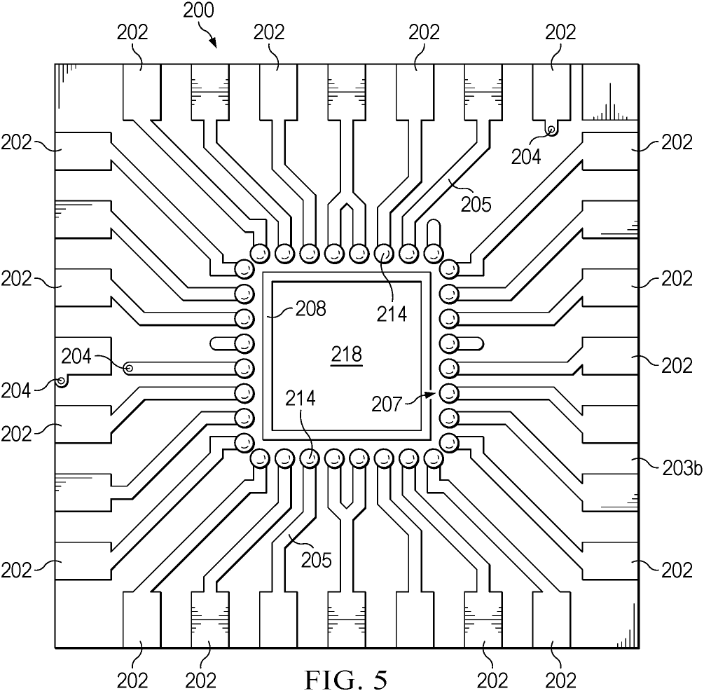

FIG. 5 is a schematic illustrating a bottom view of the substrate 200 of the fluid sensor package 104, in accordance with various examples. Metal interconnects 202 (e.g., contact pads, such as bond pads) may be positioned along a perimeter of the bottom surface 203b of the substrate 200. Metal interconnects 205 couple to the metal interconnects 202. The metal interconnects 205 and 214 terminate near the opening 218, and are separated from the sealing layer 208 by the gap 207. The sealing layer 208 covers the inner surface of the opening 218 and covers a portion of the bottom surface 203b of the substrate 200, as FIG. 5 shows.

Also, the metal interconnect 204 (e.g., via) extends through the substrate 200 and terminates at the bottom surface 203b of the substrate 200. In some examples, the metal interconnect 204 can be coupled to one of the metal interconnects 202 (e.g., contact pads) and to substrate 102 (FIGS. 2A and 2B). In some examples, the metal interconnect 204 can be coupled to one of the metal interconnects 205 and to sensor IC 209. In examples, the metal interconnect 204 has an inner surface that is covered by the sealing layer 208, the metal interconnect 206, or by another sealing layer (e.g., copper, nickel, palladium, gold, silver, or a combination thereof). In examples, the metal interconnect 204 is filled with a non-conductive material, such as epoxy. In some examples, fluid sensor package 104 can include multiple metal interconnects 204.

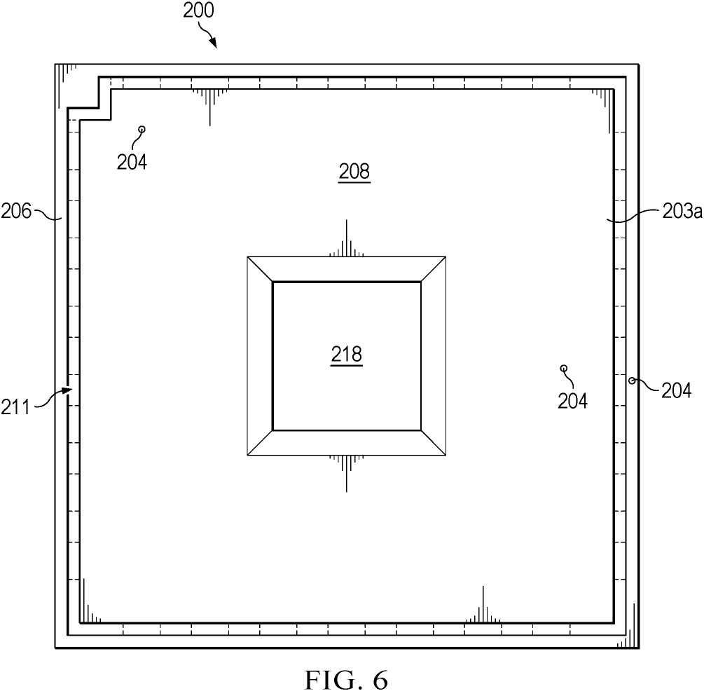

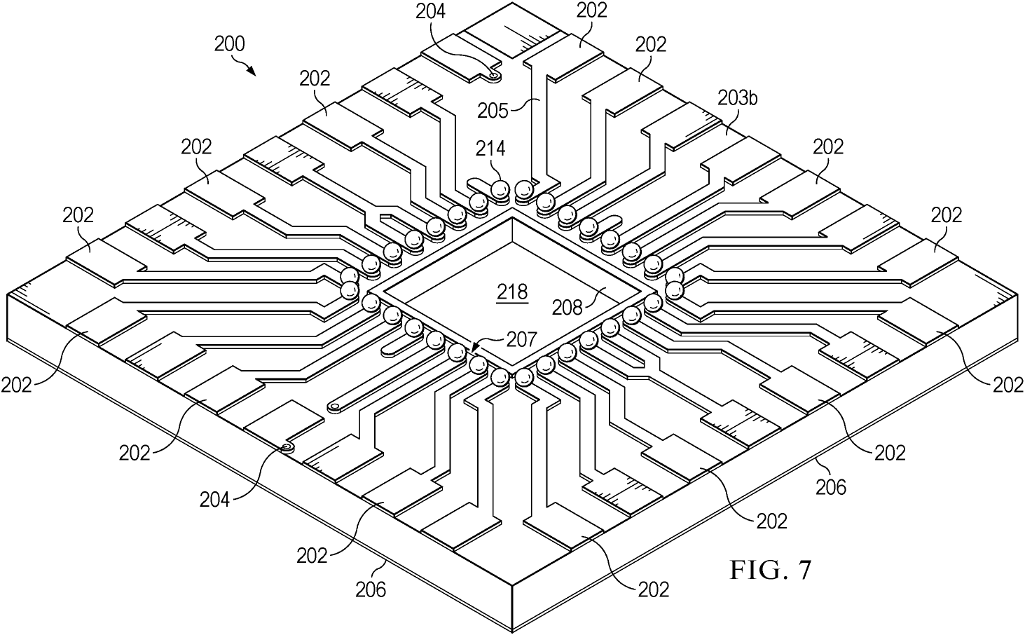

FIG. 6 is a schematic of a top view of the substrate 200 of the fluid sensor package 104 (FIGS. 2A and 2B), and FIG. 7 is a schematic of a perspective view of the substrate 200, in accordance with various examples. At least a portion of the top surface 203a of the substrate 200 can be covered by the sealing layer 208. Metal interconnect 206 covers another portion of the top surface 203a of the substrate 200. For example, the metal interconnect 206 may be in the form of a ring along a perimeter of the top surface 203a of the substrate 200. In examples, the metal interconnect 204 (e.g., a via) terminates at the metal interconnect 206, and the metal interconnect 204 is coupled to the metal interconnect 206. Additional vias may be included, for example, to provide electrical connections between the sealing layer 208, the metal interconnect 206, and various metal interconnects 202, 205 on the bottom surface 203b of the substrate 200 (FIG. 5).

In some examples, the metal interconnect 206 and the sealing layer 208 may form electrodes to detect fluid leakage/spilling over the top surface 203a of the substrate 200. Specifically, the gap 211 separates the sealing layer 208 from the metal interconnect 206. If a fluid flows across the sealing layer 208 towards the perimeter of the substrate 200 and spreads across the gap 211, the fluid may carry current between the metal interconnect 206 and the sealing layer 208, thereby equalizing the differing potentials on the metal interconnect 206 and the sealing layer 208. The sensor IC 209 or another electronic component on substrate 102, which can be coupled to the sealing layer 208 and the metal interconnect 206 (e.g., by way of one or more vias, such as metal interconnect 204), may detect such equalization of the voltage potentials, for example, by detecting a current between the metal interconnect 206 and the sealing layer 208. The sensor IC 209 and/or other electronic component can take a particular action responsive to detecting the fluid leakage, such as disabling/shutting down the power supply to the fluid sensor package 104, to prevent electrical damage and electrical shock.

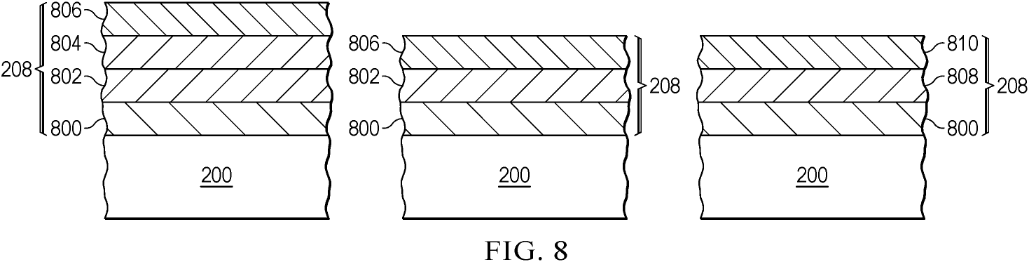

In examples, the sealing layer 208 includes multiple sub-layers. FIG. 8 is a schematic illustrating cross-sectional views of example sealing layers 208 of the fluid sensor package 104. In some examples, the sealing layer 208 is formed on the substrate 200 and includes an electroplated copper sub-layer 800, an electroless nickel sub-layer 802 on the copper sub-layer 800, an electroless palladium sub-layer 804 on the nickel sub-layer 802, and an immersion gold or silver sub-layer 806 on the palladium sub-layer 804. In examples, the copper sub-layer 800 has a thickness ranging from 14 microns to 40 microns, the nickel sub-layer 802 has a thickness ranging from 3 microns to 6 microns, the palladium sub-layer 804 has a thickness ranging from 0.05 microns to 0.30 microns, and the gold or silver sub-layer 806 has a thickness above 0.03 microns.

In some examples, the sealing layer 208 is formed on the substrate 200 and includes the electroplated copper sub-layer 800, the electroless nickel sub-layer 802 on the copper sub-layer 800, and the immersion gold or silver sub-layer 806 on the nickel sub-layer 802. In such examples, the copper sub-layer 800 may have a thickness ranging from 14 microns to 40 microns, the nickel sub-layer 802 may have a thickness ranging from 3 microns to 6 microns, and the gold or silver sub-layer 806 may have a thickness above 0.05 microns. In some examples, the sealing layer 208 is formed on the substrate 200 and includes an electroplated copper sub-layer 800, an electroplated nickel sub-layer 808, and an electroplated gold or silver sub-layer 810. In such examples, the thickness of the copper sub-layer 800 may range from 14 microns to 40 microns, the thickness of the nickel sub-layer 808 may range from 3 microns to 7 microns, and the thickness of the gold or silver sub-layer may range from 0.25 microns to 0.70 microns. Other metal sub-layers and combinations of metal sub-layers are contemplated and included in the scope of this disclosure. Any gold or silver sub-layer, whether applied by immersion or plating processes, can have a purity of at least 99% to prevent/reduce corrosion or dissolution due to exposure to the fluid.

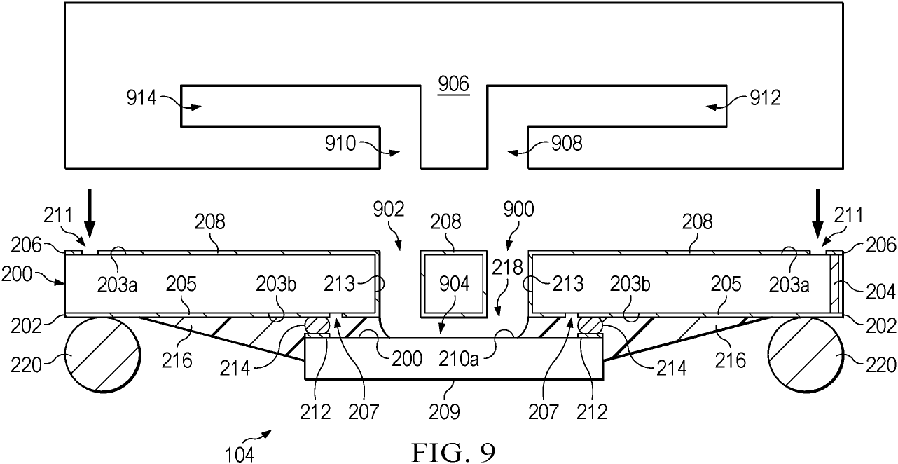

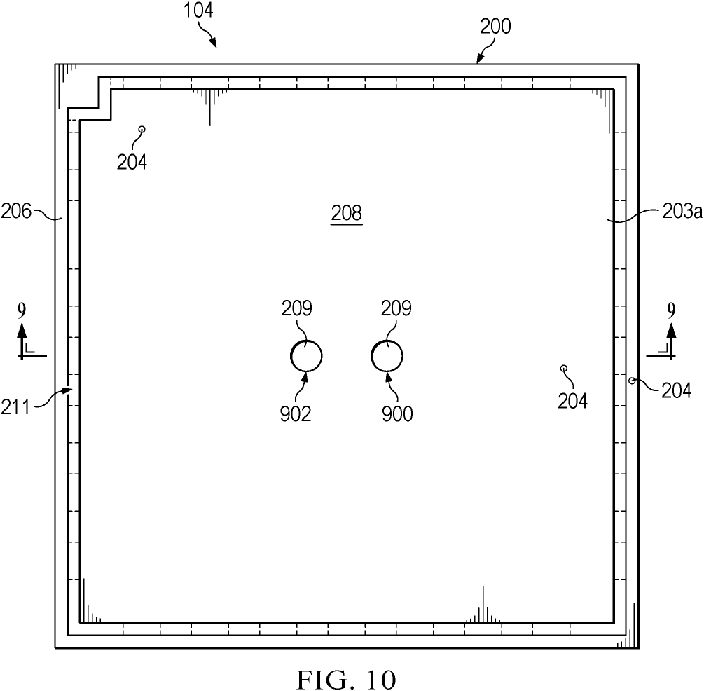

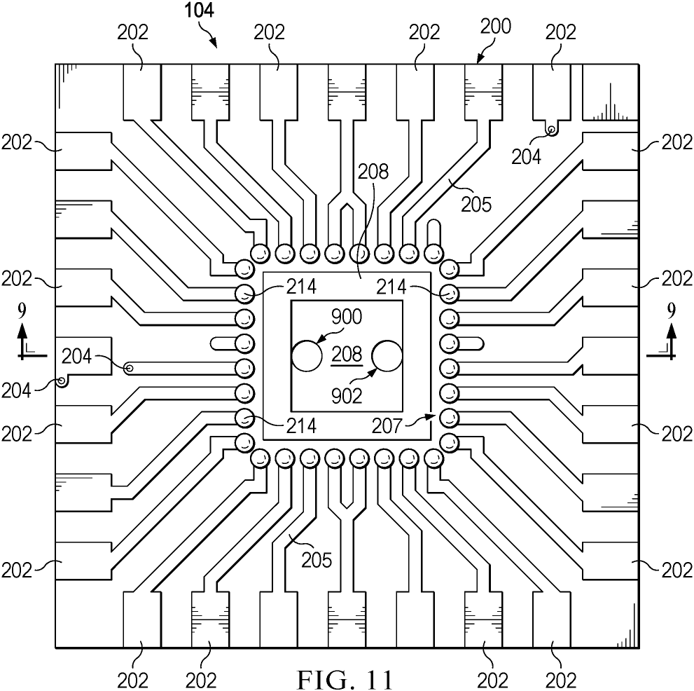

FIG. 9 is a schematic illustrating a cross-sectional view of the fluid sensor package 104 and a cartridge, FIG. 10 is a schematic illustrating a top view of the fluid sensor package 104 of FIG. 9, and FIG. 11 is a schematic illustrating a bottom view of the substrate 200 of the fluid sensor package 104, in accordance with various examples. The example fluid sensor package 104 of FIGS. 9, 10, and 11 include multiple openings, including openings 900 and 902, in the substrate 200. In some examples, opening 900 can be an inlet, and opening 902 can be an outlet. The substrate 200 also includes a sensing channel 904 between the openings 900 and 902. In some examples, a fluid to be sensed by the sensor IC 209 may flow into the opening 900, through the sensing channel 904, and exit via the opening 902.

In examples, fluid sensor package 104 can interface with a cartridge 906. An example cartridge 906 may include an opening 908, an opening 910, a cavity 912, and a cavity 914. Opening 908 may extend to cavity 912, and opening 910 may extend to cavity 914. In some examples, the cartridge 906 may contact the substrate 200, with the opening 908 aligned with the opening 900 and with the opening 910 aligned with the opening 902. Fluid sensor package 104 may include various mechanisms, such as screws, rods, support members, and similar structures (not expressly shown) to establish and maintain alignments between the openings. In some examples, a fluid may flow from cavity 912, through openings 908 and 900, and into the sensing channel 904 where the sensor IC 209 senses properties of the fluid. The fluid can then exit through the openings 902 and 910, and into cavity 914. The fluid may be provided to and removed from the cartridge 906 using any suitable apparatus, including valves, pumps, etc.

The sealing layer 208 may cover some or all areas of the substrate 200 that are exposed to the fluid. For example, the sealing layer 208 may cover some or all of the opening 900, some or all of the sensing channel 904 (with the exception of the sensor IC 209), some or all of the opening 902, some or all of the bottom surface 203b of the substrate 200, and some or all of the top surface 203 a of the substrate 200. The sealing layer 208 may include any of the sub-layer combinations shown in FIG. 8.

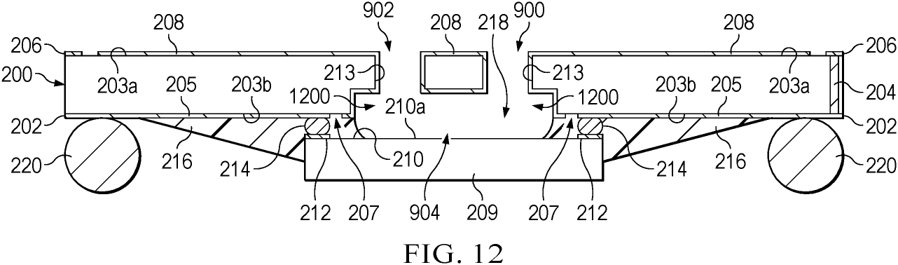

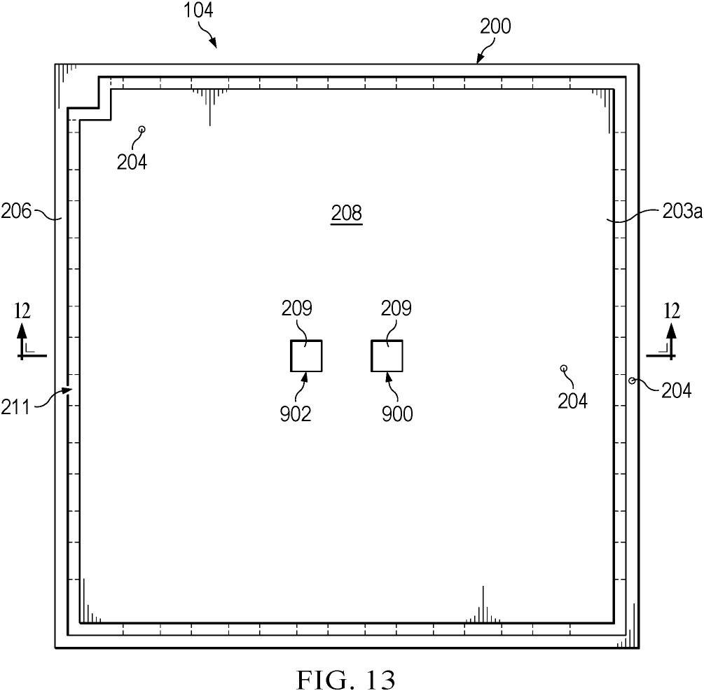

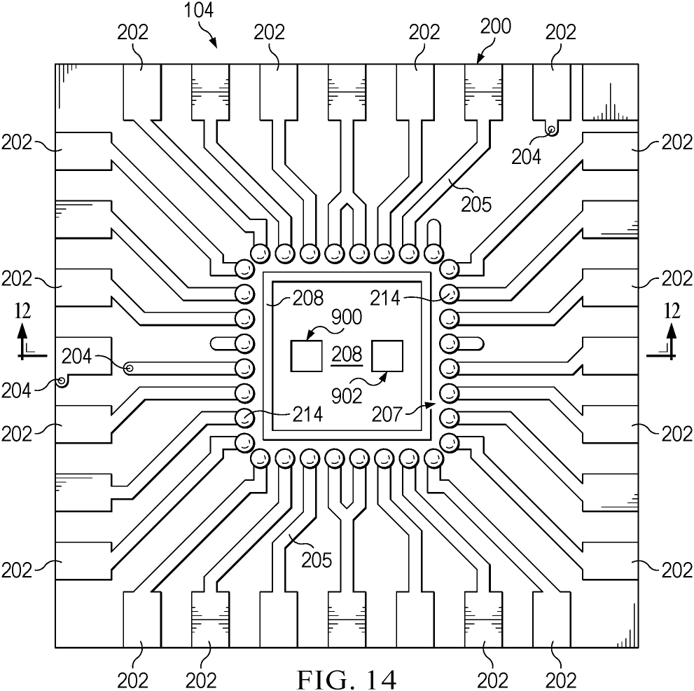

FIG. 12 is a schematic illustrating a cross-sectional view of another example of the fluid sensor package 104, FIG. 13 is a schematic illustrating a top view of the fluid sensor package 104 of FIG. 12, and FIG. 14 is a schematic illustrating a bottom view of the substrate 200 of the fluid sensor package 104 of FIG. 12, in accordance with various examples. The fluid sensor package 104 of FIGS. 12-14 can include similar structures and components as the example fluid sensor package 104 of FIGS. 9-11. But the openings 900 and 902, and sensing channel 904, may have different cross-sectional shapes between FIGS. 9-11 and FIGS. 12-14. For example, the openings 900 and 902 and sensing channel 904 in FIGS. 9-11 may have circular or rounded cross-sectional shapes, while the openings 900 and 902 and sensing channel 904 in FIGS. 12-14 may have rectangular cross-sectional shapes. In addition, the cross-sectional area of the sensing channel 904 in FIGS. 12-14 may be larger than in FIGS. 9-11. Also, the sensing channel 904 of FIGS. 12-14 may include a recessed area 1200, , which causes the sealing layer 216 to terminate farther away from the openings 900 and 902 than would be the case if the recessed area 1200 were not present, thereby providing the technical benefit of facilitating fluid flow between the openings 900 and 902.

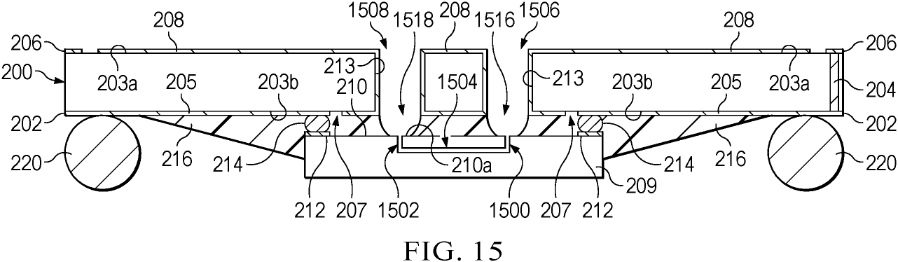

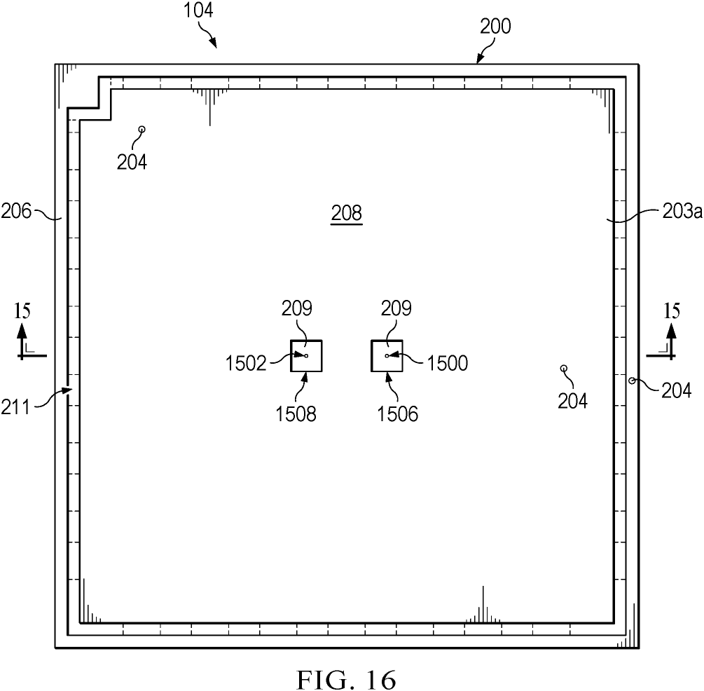

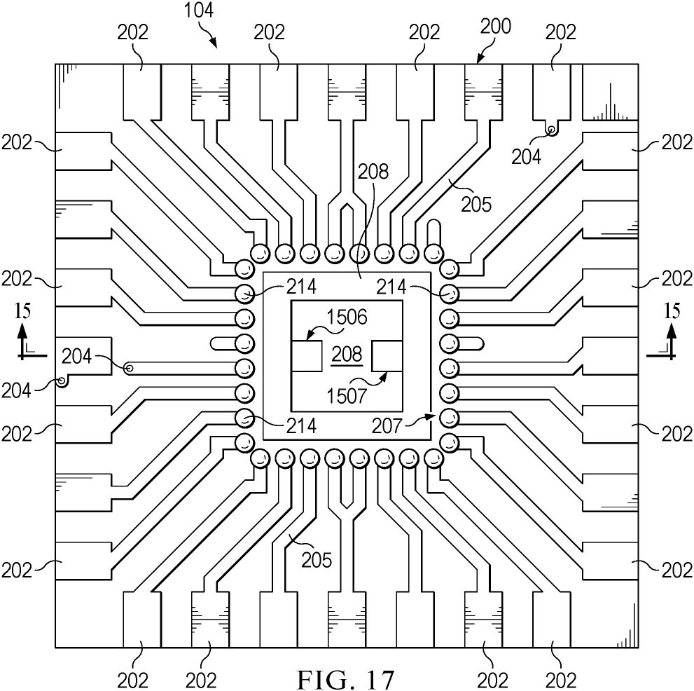

FIG. 15 is a schematic illustrating a cross-sectional view of another example of the fluid sensor package 104, FIG. 16 is a schematic illustrating a top view of the fluid sensor package 104 of FIG. 15, and FIG. 17 is a schematic illustrating a bottom view of the substrate 200 of the fluid sensor package 104 of FIG. 15, in accordance with various examples. In FIGS. 15-17, the fluid sensor package 104 can interface with a sensor IC 209 having openings 1500 and 1502 and a microfluidic channel 1504 coupled between openings 1500 and 1502. A fluid can enter the sensor IC 209 via the opening 1500, flow through the sensing channel 1504, and exit via the opening 1502. The sensor IC 209 senses properties of the fluid as the fluid flows through the sensing channel 1504. For example, the sensor IC 209 includes a sensing area above and/or below the sensing channel 1504.

The substrate 200 may include an opening 1506 and an opening 1508. Also, the sealing layer 216 includes an opening 1516 between the opening 1506 of the substrate 200 and the opening 1500 of the sensor IC 209. Further, the sealing layer 216 includes an opening 1518 between the opening 1508 of the substrate 200 and the opening 1502 of the sensor IC 209. The cross-sectional areas of openings 1506 and 1508 can be larger than the respective openings 1500 and 1502, which can have microscales, and the fluid can propagate through the openings 1500 and 1502 and the sensing channel 1504.

In examples, the opening 1506 has a larger volume than the volume of opening 1500, because IC wafer manufacturing, which can incorporate such microfluidic cavities, allows smaller dimensions and, hence, higher integration density than fluidic cavities such as openings 1506 and 1508. For similar reasons, in examples, the opening 1508 has a larger volume than the volume of opening 1502. The sealing layer 208 covers areas of the substrate 200 that may be exposed to fluid, including the inner surfaces of the opening 1506 and the opening 1508. The remainder of the structure of FIG. 15 is similar to that described above with respect to FIGS. 2A, 2B, 9, 12, and 15. A cartridge similar to cartridge 906 but adapted for use with the structure of FIG. 15 may be useful to provide and receive fluid to and from the opening 1506 and the opening 1508.

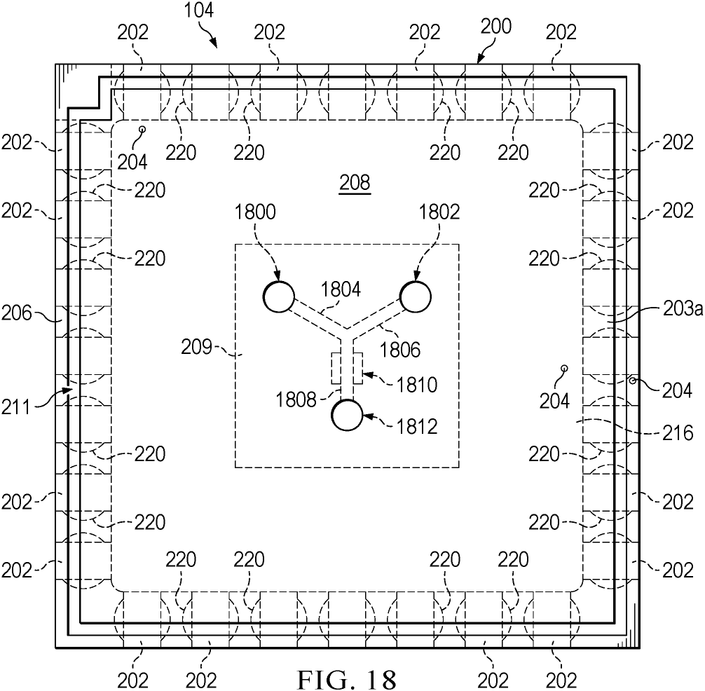

In some examples, the substrate 200 of an example fluid sensor package 104 includes multiple inlets. Different fluids may enter through the multiple inlets, and the fluids may mix or have a chemical reaction between them within the substrate 200 to form a solution. The substrate 200 may then sense properties of the solution (or monitor a state of the chemical reaction) when the solution is in the substrate 200. FIG. 18 is a schematic illustrating a top view of an example fluid sensor package 104. The fluid sensor package 104 of FIG. 18 is similar to the other example fluid sensor packages 104 described above, except that the fluid sensor package 104 of FIG. 18 includes multiple inlets. Specifically, the fluid sensor package 104 includes an opening 1800, an opening 1802, a fluid channel 1804, a fluid channel 1806, a sensing channel 1808, and an opening 1812. Openings 1800 and 1802 can be inlets and opening 1812 can be an outlet. The fluid sensor package 104 also includes a sensor IC 209 having a sensing area 1810. The sensing area 1810 is aligned with the sensing channel 1808. A first fluid to be tested/sensed may enter the opening 1800, and a second fluid to be tested/sensed may enter the opening 1802. The first fluid flows through the fluid channel 1804, and the second fluid flows through the fluid channel 1806. The fluid channels 1804 and 1806 intersect at the sensing channel 1808. Accordingly, the first and second fluids can mix (or have a chemical reaction between them) to form a solution in the sensing channel 1808. The sensor IC 209 (and, more specifically, the sensing area 1810) sense properties of the solution. The solution exits through the outlet 1812. In examples, the sensing area 1810 is positioned at least a particular distance (e.g., 50 microns) from the intersection point of the fluid channels 1804 and 1806 to allow the first and second fluids to mix (or for a chemical reaction to complete) to a certain degree before properties of the resulting solution are detected. The sealing layer 208 covers areas of the substrate 200 that may be exposed to any fluid. A cartridge similar to cartridge 906 but adapted for use with the structure of FIG. 18 may be useful to provide and receive fluid.

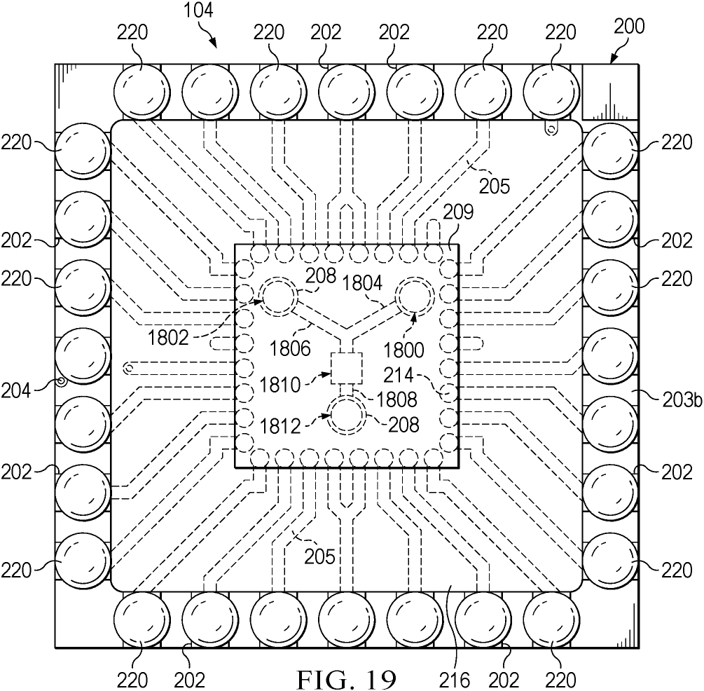

FIG. 19 is a schematic illustrating a bottom view of the fluid sensor package 104 of FIG. 18, in accordance with various examples. Specifically, FIG. 19 shows the sealing layer 208 covering portions of the bottom surface of the sensor IC 209. For example, the sealing layer 208 covers the inner surfaces of the openings 1800, 1802 and 1812 and covers portions of the bottom surface of the sensor IC 209 within 10-50 microns of the corresponding opening 1800 or 1802 and opening 1812.

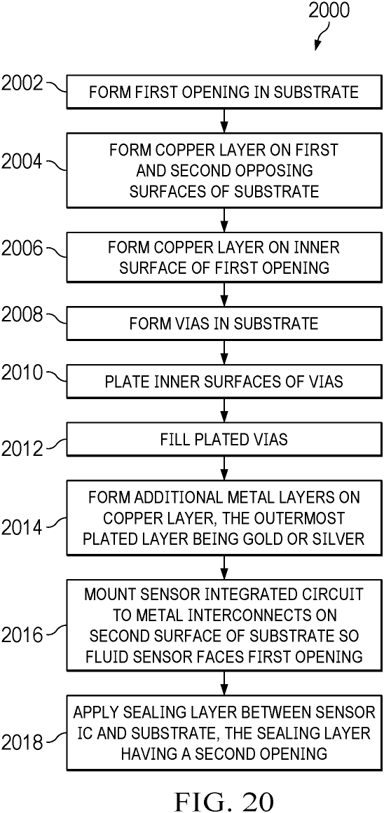

FIG. 20 is a flow diagram of a method 2000 for manufacturing a fluid sensor package, such as the fluid sensor package 104, in accordance with various examples. The method 2000 may begin with forming a first opening in a substrate (2002). For example, the openings 201 (FIG. 2A), 900 and 902 (FIGS. 9 and 12), 1506 and 1508 (FIG. 15), and 1800, 1802 and 1812 (FIG. 18) in the substrate 200 (e.g., FR-4 PCB) may be formed using any suitable technique (e.g., machining). The method 2000 includes forming a copper layer on first and second opposing surfaces of the substrate (2004) and on the inner surface of the first opening (2006). For example, the copper sub-layer 800 (FIG. 8) in the sealing layer 208 of FIGS. 2A, 2B, 9, 12, 15, and 18 may be formed using an electroplating technique.

The method 2000 may include forming vias in the substrate (2008) and plating the inner surfaces of the vias (2010). For example, the metal interconnects 204 in FIGS. 2A, 2B, 9, 12, 15, and 18 may be formed using any suitable technique (e.g., a machining technique) and the inner surfaces of the metal interconnects 204 may be electroplated using copper. The method 2000 includes filling the plated vias (2012). For example, the metal interconnects 204 may be filled with an epoxy or other non-conductive material. In examples, a conductive material may be useful to fill the metal interconnects 204.

The method 2000 may include forming additional metal layers on the copper layer, with the outermost plated layer being gold or silver (2014). For example, one or more of the sub-layers shown in FIG. 8, such as electroless nickel sub-layer 802, electroless palladium sub-layer 804, immersion gold or silver sub-layer 806, electroplated nickel sub-layer 808, and/or electroplated gold or silver sub-layer 810, may be formed in the sequence shown in FIG. 8 on the copper sub-layer 800. Such sub-layers may be formed on a portion of the top surface of the substrate 200, a portion of the bottom surface of the substrate 200, and the inner surfaces of various openings in the substrate 200 (e.g., openings 201 (FIGS. 2A and 2B); 900 and 902 (FIGS. 9 and 12); openings 1506 and 1508 (FIG. 15); openings 1800, 1802, and 1812 (FIG. 18). In some examples, such sub-layers may be formed on the inner surfaces of the vias (e.g., metal interconnects 204 in FIGS. 2A, 2B, 9, 12, 15, and 18).

The method 2000 includes mounting a sensor IC to metal interconnects on the bottom surface of the substrate such that a fluid sensor of the sensor IC faces the first opening formed in the substrate (2016). For example, the sensor IC 209 may be coupled to the bottom surface of substrate 200 by metal interconnects 214, with the sensing area 210a facing the opening 201 (FIGS. 2A and 2B). As FIGS. 9, 12, 15, and 18 show, a sensor IC 209 may be coupled to the bottom surface of a substrate 200 having multiple openings (e.g., inlets and outlets), and in such examples, the sensing area of the substrate 200 faces such openings in the substrate 200.

The method 2000 includes applying a sealing layer between the sensor IC and the substrate, where the sealing layer has a second opening (2018). For example, the sealing layer 216 (e.g., epoxy) may be applied between the substrate 200 and the sensor IC 209. In examples, the sealing layer 216 is formed by applying an epoxy near the metal interconnects 214, and capillary action causes the epoxy to extend through the space between the bottom surface 203b of the substrate 200 and the sensor surface 210 of the sensor IC 209, toward the sensing area 210a. In some examples, the sealing layer 216 is formed by applying a layer of adhesive on the sensing surface 210 of the sensor IC 209 and/or on the bottom surface 203b of the substrate 200 and surrounding the metal interconnects 214, followed by mounting the sensor IC 209 on the metal interconnects 214. In the event the layer of adhesive comprises ACF, the ACF’s vertically conductive properties may substitute for the metal interconnects 214, which may be omitted. Similar sealing layers 216 may be applied in the examples of FIGS. 9, 12, 15, and 18.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

In this description, unless otherwise stated, “about,” “approximately” or “substantially” preceding a parameter means being within +/- 10 percent of that parameter. Modifications are possible in the described examples, and other examples are possible within the scope of the claims.

What is claimed is:

1. An apparatus, comprising:
a substrate having opposite first and second surfaces, the substrate including:
a first opening through the substrate;
a first sealing layer covering an inner surface of the first opening, the inner surface extending between the first and second surfaces; and
contact pads on the second surface;
a fluid sensor having a sensor surface facing the second surface and the first opening;
metal interconnects coupled between the sensor surface and the contact pads; and
a second sealing layer between the second surface and the sensor surface, in which the second sealing layer surrounds the metal interconnects and includes a second opening below the first opening, and at least part of the sensor surface is exposed through the first and second openings.

2. The apparatus of claim 1, wherein the first sealing layer comprises a metal layer.

3. The apparatus of claim 2, wherein the metal layer includes gold and one or more of copper, nickel, and palladium.

4. The apparatus of claim 1, wherein the second sealing layer comprises an adhesive.

5. The apparatus of claim 4, wherein the second sealing layer comprises an epoxy.

6. The apparatus of claim 1, wherein:
the second sealing layer comprises an epoxy,
the inner surface is a first inner surface,
the second opening has a second inner surface, and
the second inner surface is a sloping surface.

7. The apparatus of claim 1, wherein:
the inner surface is a first inner surface;
the substrate includes a third opening that extends between the first and second surfaces, the third opening having a second inner surface and extending to the second opening in the second sealing layer; and
the apparatus further comprises a third sealing layer covering the second inner surface of the third opening.

8. The apparatus of claim 1, further comprising first and second metal layers on the first surface, the first metal layer coupled to the first sealing layer, the second metal layer being electrically isolated from the first metal layer,
wherein the substrate includes a via extending between the first and second surfaces, in which the via is coupled between the second metal layer and a contact pad of the contact pads on the second surface.

9. An apparatus, comprising:
a first substrate having opposite first and second surfaces, the first substrate including:
a first opening through the first substrate;
a first sealing layer covering an inner surface of the first opening, the inner surface extending between the first and second surfaces; and
contact pads on the second surface;
a fluid sensor having a sensor surface facing the first opening;
metal interconnects coupled between the sensor surface and the contact pads;
a second sealing layer between the second surface and the sensor surface, in which the second sealing layer surrounds the metal interconnects and includes a second opening below the first opening, and at least part of the sensor surface is exposed through the first and second openings;
a second substrate coupled to the metal interconnects via solder members;
a container coupled to the second substrate and having a third opening above the first opening; and
a sealing ring between the container and the first surface of the first substrate.

10. The apparatus of claim 9, wherein:
the inner surface is a first inner surface;
the first substrate includes a fourth opening that extends between the first and second surfaces, the fourth opening having a second inner surface and extending to the second opening in the second sealing layer; and
the apparatus further comprises a third sealing layer covering the second inner surface of the fourth opening.

11. The apparatus of claim 10, wherein:
the container is a cartridge having a fifth opening, the fifth opening interfacing with the fourth opening in the first substrate.

12. The apparatus of claim 9, wherein the container is a polyether ether ketone (PEEK) container.

13. The apparatus of claim 9, wherein the container includes a recessed area inside which a portion of the sealing ring is positioned.

14. The apparatus of claim 9, wherein the first sealing layer is a metal or alloy.

15. The apparatus of claim 9, wherein the second sealing layer includes epoxy.

16. A method, comprising:
forming a substrate having opposite first and second surfaces and a first opening extending between the first and second surfaces;
forming a first sealing layer on an inner surface of the first opening;
mounting a fluid sensor on metal interconnects on the second surface of the substrate, the fluid sensor having a sensing area facing the first opening; and
forming a second sealing layer between the second surface of the substrate and the fluid sensor and around the metal interconnects, the second sealing layer having a second opening between the first opening and the sensing area, such that the sensing area is exposed through the first and second openings.

17. The method of claim 16, wherein forming the second sealing layer includes enabling an epoxy to flow through a space between the second surface of the substrate and the fluid sensor by capillary action.

18. The method of claim 16, wherein forming the second sealing layer includes applying a layer of adhesive around the metal interconnects prior to mounting the fluid sensor on the metal interconnects.

19. The method of claim 16, wherein forming the first sealing layer comprises performing an electroplating process using gold.

20. The method of claim 16, wherein forming the first sealing layer comprises performing an electroplating process using silver.
